(19) United States
(12) Patent Application Publication
(10) Pub. No.: US 2015/0053146 A1
(43) Pub. Date: Feb. 26, 2015

(54) Shock Absorbing Rope Insert for Livestock

(71) Applicant: Tommie Carroll Gipson, Eaton, CO (US)

(72) Inventor: Tommie Carroll Gipson, Eaton, CO (US)

(21) Appl. No.: 14/206,465

(22) Filed: Mar. 12, 2014

Related U.S. Application Data
(60) Provisional application No. 61/959,304, filed on Aug. 20, 2013.
(60) Provisional application No. 61/904,692, filed on Nov. 15, 2013.

(51) Int. Cl. A01K 15/00

(52) U.S. Cl. CPC A01K 15/003
USPC 119/795

(57) ABSTRACT

Embodiments of the present invention include a flexible rope insert having an elasticized central portion that is capable of stretching. This stretchable rope insert allows for limited stretching of the rope when an animal is roped. The flexible rope insert cushions the shock load on a steer or other animal that is stopped too abruptly with a rope.

### CROSS-REFERENCE TO RELATED APPLICATION

The present application, pursuant to 35 U.S.C. 111(b), claims the benefit of the earlier filing date of provisional application Ser. No. 61/959,304 filed Aug. 20, 2013, and entitled “Shock Absorbing Rope” and of provisional application Ser. No. 61/904,692 filed Nov. 15, 2013, and entitled “Shock Absorbing Rope Insert for Livestock.”

### FIELD OF THE INVENTION

The present invention relates to a flexible rope insert that allows for limited stretching of the rope when roping livestock. This flexible rope insert cushions the shock load on horses and cattle that are stopped abruptly with a rope.

### DESCRIPTION OF THE RELATED ART

Rodeo contests have become popular in recent years, particularly in the western states of the United States, and many cowboys and other western riders have become highly skilled in the performance of certain cattle handling feats, such as bulldogging, steer-roping, and calf-toping. Roping, for example, is increasingly popular as a family sport, and today there are more than 100,000 members in the United States Team Roping Association. Ropers often exhibit their skills in competitions where they actively compete with each other for prize money before large audiences during rodeo performances.

For example, the act of team roping consists of a header (horn roper) that catches the horns of a steer and a heeler who ropes the heels (hind legs) of the steer. The header catches the horns of the steer and begins leading the steer, so that the steer is positioned and available for the heeler to rope its hind legs. Sometimes when the header ropes the horns of the steer, the steer is stopped very abruptly causing injury to the steer and sometimes to the withers and fetlocks, of the horse as well.

A need exists for an improved means of roping steers and other livestock to minimize the shock load on both the calf or steer being roped and the horse from which the calf or steer is roped from in order to avoid injuring either animal.

### SUMMARY OF THE INVENTION

The present invention provides a flexible rope insert having an elasticized central portion that is capable of stretching. This stretchable rope insert allows for limited stretching of the rope when an animal is roped. This flexible rope insert cushions the shock load on a steer or other animal that is stopped too abruptly with a rope.

One embodiment of the present invention is a shock absorbing rope insert including: a) a first annular end loop and a second annular end loop, wherein each end. loop has an opening; b) an expandable shock cord joining the first and second end loops, wherein the shock cord is wound multiple times between the opening in the first end loop and the opening in the second end loop, wherein a first end and a second end of the wound shock cord are joined; and c) a stretchable elastomeric cover fitted to cover the wound shock cord and a portion of the first and second end loops.

Another embodiment of the present invention is a shock absorbing rope insert including: a) a first end loop and a second end loop, wherein each end loop is rounded with an opening; b) an expandable shock cord joining the first and second end loops, wherein the shock cord is wound multiple times between the opening in the first end loop and the opening in the second end loop, wherein a first end and a second end of the wound shock cord are joined and wherein the shock cord expands between 50% and 200% in length under a 500 pound force; and d) a stretchable elastomeric cover fitted to cover the wound shock cord and a portion of the first and second end loops.

Yet another embodiment of the invention is a method of roping a steer including the steps of: a) obtaining a shock absorbing rope insert, wherein the rope insert includes i) a first annular end loop and a second annular end loop, wherein each end loop has an opening; ii) an expandable shock cord joining the first and second end loops, wherein the shock cord is wound multiple times between the opening in the first end loop and the opening in the second end loop and wherein a first end and a second end of the wound shock cord are joined; and iii) a stretchable elastomeric cover fitted to cover the wound shock cord and a portion of the first and second end loops; b) connecting the first end loop of the rope insert to a first end of a lariat; and c) lassoing a steer with a noose at a second end of the lariat; whereby the expansion of the rope insert when the steer is lassoed reduces the likelihood of injury to the steer and the roping horse.

Still another embodiment of the invention is a method of reducing injuries to a horse and a steer during team roping, the method including the steps of: a) obtaining a shock absorbing rope insert, wherein the rope insert includes i) a first annular end loop and a second annular end loop, wherein each end loop has an opening; ii) an expandable shock cord joining the first and second end loops, wherein the shock cord is wound multiple times between the opening in the first end loop and the opening in the second end loop and wherein a first end and a second end of the wound shock cord are joined and wherein the expandable shock cord elongates from 50% to 200% in length under a 500 pound force; and iii) a stretchable elastomeric cover fitted to cover the wound shock cord and a portion of the first and second end loops; b) connecting the first end loop of the rope insert to a first end of a lariat; and c) connecting the second end loop to the saddle horn of a heeler horse; and d) lassoing the legs of a steer or a calf with a noose at a second end of the lariat; whereby the expansion of the rope insert when the steer is lassoed, reduces the likelihood of injury to the steer and heeler horse.

The foregoing has outlined rather broadly several aspects of the present invention in order that the detailed description of the invention that follows may be better understood. Additional features and advantages of the invention will be described hereinafter which form the subject of the claims of the invention, it should be appreciated by those skilled in the art that the conception and the specific embodiment disclosed might be readily utilized as a basis for modifying or redesigning the structures for carrying out the same purposes as the invention. It should be realized by those skilled in the art that such equivalent constructions do not depart from the spirit and scope of the invention as set forth in the appended claims.

### BRIEF DESCRIPTION OF THE DRAWINGS

For a more complete undemanding of the present invention, and the advantages thereof, reference is now made to the following descriptions taken in conjunction with the accompanying drawings, in which:

FIG. 1A is an oblique view taken of one embodiment of the rope insert.

FIG. 1B is an oblique view of an end section of one embodiment of the rope insert.

FIG. 2 is an oblique view of the interior components of the rope inset.

### DESCRIPTION OF THE PREFERRED EMBODIMENTS

Embodiments of the present invention include a flexible rope insert having an elasticized central portion that is capable of stretching. This stretchable rope insert allows for limited stretching of the rope when an animal is roped. This flexible rope insert cushions the shock load on a steer or other animal that is stopped abruptly with a rope.

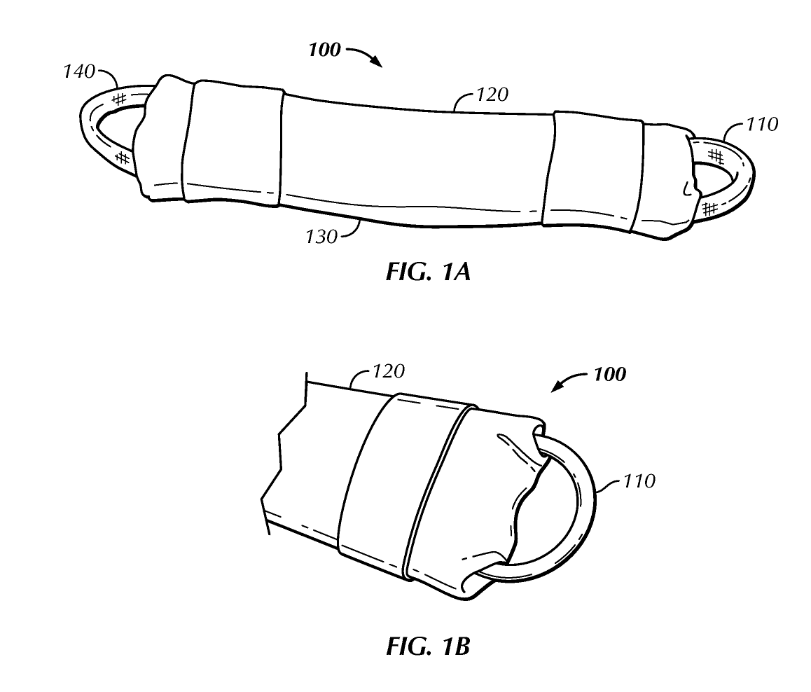

One embodiment of the rope insert 100, which lessens the sudden impact on an animal that is abruptly stopped when it is roped, is illustrated in FIG. 1. The rope insert 100 has two end loops 110 and a central portion 120. The rope insert 100 is covered with an elastomeric material 130 that is stretchable.

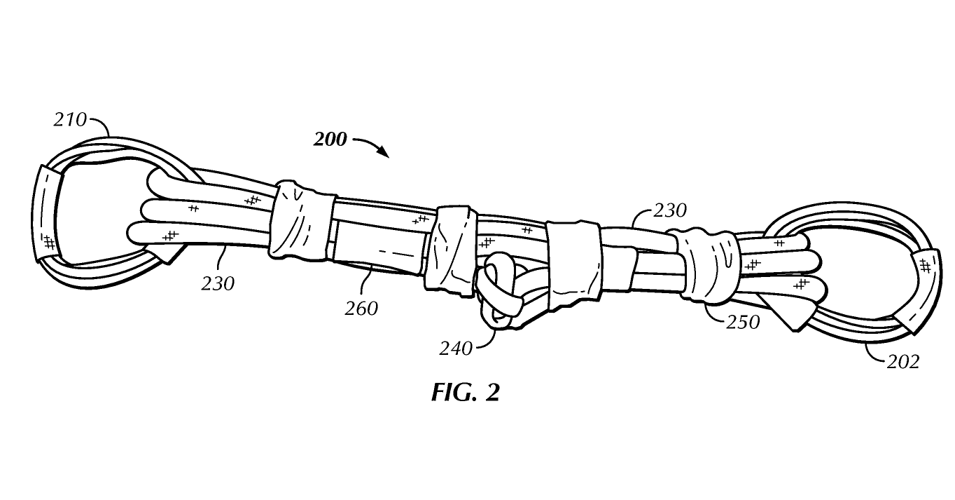

The insert interior 200 (i.e., the rope insert of FIG. 1 without its outer covering 130) is shown in FIG. 2. The insert interior 200 also exhibits two end loops 210 and a central portion 230.

The end loops 110 are typically circular or oval in shape and are connected by the central portion 230. In addition, the end loops 110 are made of a strong material that is resistant to ultraviolet degradation and that is climate and wear resistant. The end loops 110 should have minimal stretching ability; preferably the end loops will not elongate more than 10% under a pressure force of at least 500 pounds.

One embodiment of the end loops 110 is seen in FIG. 1A. The internal structure of this embodiment of the end loop 110 is shown in FIG. 2. This embodiment of the end loop 210 is made of a strong cord material 202 such as parachute cord. The selected cord 202 exhibits minimal stretching ability and does not elongate more than 10% when 500 pounds of force are applied to the ends of the cord material. Each end loop 210 is made by coiling a length of the cord material 202 multiple times to form a roughly oval loop with an opening. Although the number of coils of the cord material selected for each end loop 210 may vary widely, typically each end loop 210 will contain three to six coils of the cord material 202.

Once the cord material 202 has been coiled, the two ends of the cord material are joined together using a square knot or any other joining means known to one skilled in the art. Two opposed sides of the coils of the cord material of each end loop 210 are pulled away from each other and are optionally wrapped, or double wrapped, in a sturdy material for wear protection (e.g., a heat shrink material). The two end loops 210 are connected by the central portion of the rope insert as illustrated in FIG. 2.

Another embodiment of the end loops 110 is seen in FIG. 1B. This embodiment of the end loop 110 is a metal ring. The metal rings are stable to climate conditions and are very wear resistant.

The end loops 110, either the wrapped cord embodiment or the metal ring embodiment, are joined by multiple loosely wound cods of a shock cord 230. The shock cord 230 is wound through the center opening of each end loop 110 for a selected number of coils. Although the number of coils of the shock cord used may vary widely, typically the shock cord 230 will be wound, through the center of each end loop 110 from three to six times. The length of the wound shock cord is variable, but should be at least two to three times the diameter of the opening of one of the end loops.

Once the two end loops 110 are connected with the shock chord windings, the two ends of the shock cord 230 are joined using a square knot 240 or any other joining means known to one skilled in the art. The windings of the shock cord 230 are typically held together by an elastomeric material 250, such as large rubber bands. In addition, the shock cord is optionally stabilized by joining one strand of the shock cord, on each side of the joining means 240, with an adjoining strand, of the shock cord using an elastomeric material 260, which is the same or different front the material 250 used to hold all of the windings of the shock cord together.

The shock cord 230 must be flexible, strong and elastic. The shock cord 230 must be able to elongate from 50% to 200% (i.e., a 10 inch length of shock cord must be able to elongate to a length of 15 inches to 30 inches) when subjected to a 500 pound force. Preferably, the shock cord 230 will elongate 100% to 140% (i.e., a 10 inch length of shock cord would be able to elongate to a length of 20 inches to 24 inches) under a 500 pound force. For example, an elasticized rope such as a bungee cord may be used as the shock cord 230. However, any engineered stretchable cord that meets the requirements for the shock cord 230 may be used.

Once the insert interior 200 is assembled the insert interior is covered with a stretchable elastomeric material 130. One example of a suitable elastomeric material is ethylene propylene diene monomer robber, or EPDM. The stretchable elastomeric material 130 must be able to stretch or elongate at least 100% and will preferably elongate from 150% to 400% under a 500 pound force. In addition, whatever stretchable material is used to cover the rope insert 100, it should be heat, ozone, and weather resistant.

Typically, the insert interior 200 is inserted into a tubular elastomeric material. The ends of the tubular elastomeric material are altered to cover the entire rope insert interior 200, except for a portion of each end loop. The wrapped rope insert 100 is shown in FIG. 1A.

If the end loops 110 are made of a non-metallic material, the portion of each end loop that is not wrapped in the outer elastomeric wrap 130 is typically covered with a durable material. The end loop wrap 140, such as shown in FIG. 2, is typically a flexible but minimally stretchable material that is climate and wear resistant.

Use of the Rope Insert

The rope insert 100 is attached to a rope or lariat, for use in roping

livestock. The rope insert 100 is particularly used in certain rodeo events such as team roping, calf roping, and the like. Ropes having the rope insert 100 are also used to tie up horses or other livestock that are prone to pull back. The rope insert is much needed for the health and humane treatment of horses and cattle. The rope insert has been endorsed by ropers, veterinarians, horse trainers and stock contractors.

The rope insert 100 may be attached to a lariat or rope at either end of the rope or at any position in the central length of the rope. A lariat is defined herein as a rope having a noose at one end that is used to rope livestock. The end loops 110 are generally very similar or identical so that the rope insert 100 is typically non-directional in its attachment.

The rope insert is often used in rodeo roping events with one end loop 110 attached to a lariat and the opposed end loop 110 attached to the saddle horn either by a quick release mechanism or by a rope that goes around the saddle horn. For example in team roping events, the roped calf or steer undergoes high pressure jerks that can injure the animal. In addition, the heeler horse often sustains injuries to its fetlocks or withers with the abrupt high pressures that the heeler horse experiences when a hard running calf or steer's legs are roped and the calf or steer is suddenly stopped. The use of the rope insert 100 significantly reduces the force of these high pressure jerks and prevents horse injuries.

Another use for the rope insert 100 is in training colts that tend to pull back into standing up and minding. One end loop 110 is attached to the colt's halter and the other end loop to a fence such that as the colt tries to pull back a light, constant pressure on the halter is applied until the colt walks forward.

When the rope insert 100 is used the shock cord 230 must be able to stretch and act as a shock absorber. Of course, after the roped animal has been released the shock cord 230 must retract to its no load position.

A variety of modifications to the rope insert 100 can be made without departing from the spirit of the invention.

1. A shock absorbing rope insert including:
a. a first annular end loop with an opening;
b. a second annular end loop with an opening;
c. an expandable shock cord joining the first and second end loops, wherein the shock cord is wound multiple times between the opening in the first end loop and the opening in the second end loop, wherein a first end and a second end of the wound shock cord are joined;
d. a stretchable elastomeric cover fitted to cover the wound shock cord and a portion of the first and second end loops; and
e. a lariat, wherein the rope insert is inserted along a central length of the lariat.

2. The shock absorbing rope insert of claim 1, wherein the first and second end loops do not expand more than 10% under 500 pounds of force.

3. The shock absorbing rope insert of claim 1, wherein the first or second end loop has from three to six coils of the cord material.

4. The shock absorbing rope insert of claim 1, wherein the wound shock cord joining the first and second end loops has a length that is at least twice the diameter of the first end loop.

5. The shock absorbing roope insert of claim 1, wherein the first and second ends of the wound shock cord are joined with a square knot.

6. The shock absorbing rope insert of claim 1, wherein the shock cord is wound between the opening in the first end loop and the opening in the second end loop from three to six times.

7. The shock absorbing rope insert of claim 1, wherein the shock cord elongates from 50% to 200% in length under a 500 pound force.

8. The shock absorbing rope insert of claim 1, wherein a first end of a distal portion of a lariat is attached to the first end loop of the rope insert and a second end of the attached distal portion of the lariat has a noose for roping livestock.

9. The shock absorbing rope insert of claim 8, wherein a first end of a proximal portion of the lariat is attached to the second end loop of the rope insert and the second end of the attached proximal portion of the lariat is attached to a saddle horn.

10. The shock absorbing rope insert of claim 1, wherein the elastomeric cover stretches at least 100% under 500 pounds of force.

11. The shock absorbing rope insert of claim 1, wherein the elastomeric cover stretches from about 150% to 400% under 500 pounds of force.

12. A shock absorbing rope insert including:
a. a first end loop and a second end loop, wherein each end loop is rounded with an opening;
b. an expandable shock cord joining the first and second end loops, wherein the shock cord is wound multiple times between the opening in the first end loop and the opening in the second end loop, wherein a first end and a second end of the wound shock cord are joined and wherein the shock cord expands between 50% and 200% in length under a 500 pound force;
c. a stretchable elastomeric cover fitted to cover the wound shock cord and a portion of the first and second end loops; and
d. a lariat, wherein the rope insert is inserted along a central length of the lariat.

13. The shock absorbing rope insert of claim 12, wherein the first and second end loops are metallic rings.

14. The shock absorbing rope insert of claim 12, wherein the shock cord is wound between the opening in the first end loop and the opening in the second end loop from three to six times.

15. The shock absorbing rope insert of claim 12, wherein a first end of a distal portion of a lariat is attached to the first end loop of the rope insert, and wherein a second end of the attached distal portion of the lariat has a noose for roping livestock.

16. The shock absorbing rope insert of claim 15, wherein a first end of a proximal portion of the lariat is attached to the second end loop of the rope insert and the second end of the proximal portion of the lariat is attached to a saddle horn.

17. The shock absorbing rope insert of claim 12, wherein the elastomeric cover stretches at least 100% under 500 pounds of force.

18. The shock absorbing rope insert of claim 12, wherein the elastomeric cover stretches from about 150% to 400% under 500 pounds of force.

19. A method of roping a steer including the steps of:
a. obtaining a shock absorbing rope insert, wherein the rope insert includes
i) a first annular end loop and a second annular end loop, wherein each end loop has an opening;
ii) an expandable shock cord joining the first and second end loops, wherein the shock cord is wound multiple times between the opening in the first end loop and the opening in the second end loop and wherein a first end and a second end of the wound shock cord are joined; and
iii) a stretchable elastomeric cover fitted to cover the wound shock cord and a portion of the first and second end loops;
b. inserting the rope insert along a central length of a lariat by connecting the first end loop of the rope insert to a first end of a distal portion of the lariat and the second end loop of the rope insert to a first end of a proximal portion of the lariat; and
c. lassoing a steer with a noose at a second end of the distal portion of the lariat
whereby the expansion of the rope insert when the steer is lassoed reduces the likelihood of injury to the steer and roping horse.

20. The method of roping a steer of claim 19, wherein the expandable shock cord elongates from 50% to 200% in length under a 500 pound force.

21. A method of reducing injuries to a horse and a steer during team roping, the method including the steps of:
a. obtaining a shock absorbing rope insert, wherein the rope insert includes
i) a first annular end loop and a second annular end loop, wherein each end loop has an opening;
ii) an expandable shock cord joining the first and second end loops, wherein the shock cord is wound multiple times between the opening in the first end loop and the opening in the second end loop and wherein a first end and a second end of the wound shock cord are joined and wherein the expandable shock cord elongates from 50% to 200% in length under a 500 pound force; and
iii) a stretchable elastomeric cover fitted to cover the wound shock cord and a portion of the first and second end loops;
b. inserting the rope insert along a central length of a lariat by connecting the first end loop of the rope insert to a first end of a distal portion of the lariat and the second end loop the rope insert to a first end of a proximal portion of the lariat; and
c. connecting a second end of the proximal end of the lariat to the saddle horn of a heeler horse; and
d. lassoing the legs of a steer or a calf with a noose at a second end of the distal portion of the lariat;
whereby the expansion of the rope insert when the steer or calf is lassoed reduces the likelihood of injury to the steer or calf and heeler horse.
